(19) United States
(12) Patent Application Publication
(10) Pub. No.: US 2002/0003852 A1
(43) Pub. Date: Jan. 10, 2002

(54) Ex-vessel core melt retention device preventing molten core concrete interaction

(76) Inventors: Jong Woon Park, Yusong-Ku (KR); Seung Jong Oh, Yusong-Ku (KR); T. G. Theofanous, Santa Barbara, CA (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/742,302

(22) Filed: Dec. 22, 2000

(30) Foreign Application Priority Data
Dec. 28, 1999 (KR) 1999-63392

(51) Int. Cl. G21C 9/00

(52) U.S. Cl. 376/280

(57) ABSTRACT

The present invention relates to a safety design and risk management of a reactor of a nuclear plant, and more particularly, to an ex-vessel core melt device preventing molten core concrete interaction, which is to handle very severe accidents caused by cooling-function loss to nuclear fuel. Due to the large quantity of nuclear fuel existing in the reactor and decay heat which is latent and continuously generated within the fuel mass for a long time after the nuclear chain reaction, the nuclear fuel is melted in gross at temperature up to 2,500 degrees centigrade, and thereby the surrounding structures and a reactor vessel are attacked and damaged, and in the end, a containment building floor is eroded. This situation may cause environmental radioactivity either by ultimate penetration of the cavity floor or by the buildup of non-condensable gas pressure (i.e., pressurizing the containment building structure), unless the reaction is arrested. The ex-vessel core melt retention device preventing molten core concrete interaction, which is installed for alleviating risks due to unexpected accidents over accidents considered as a design criteria of a nuclear plant, includes: horizontal jacket pipes located on a shell boundary of a cavity floor, the horizontal jacket pipes having water inlets A formed at their lower half in an appropriate density for allowing water to enter the bottom of the pipes; vertical pipes connected at both ends of the horizontal jacket pipes in the form of a dovetail to communicate with each other; and a water supply part located at the lower portion of the horizontal jacket pipes for allowing water to enter from the whole area of the bottom.

### BACKGROUND OF THE INVENTION

1. Field of the Invention

The present invention relates to an ex-vessel core melt retention device for protecting a containment building in a nuclear power plant, and more particularly, to an ex-vessel core melt retention device, which prevents molten core concrete interaction, so that released nuclear melt can be cooled even when a reactor vessel is damaged and the core melt is released by unexpected severe accidents over accidents considered as a design criteria of a nuclear plant.

2. Description of the Related Art

When there happens a severe nuclear accident over accidents considered as design criteria of a nuclear plant and thereby core is melted, if specific measures are not taken, the molten core moves toward a reactor vessel floor and melts and damages a bottom head of the reactor vessel. At this time, the molten core, which is radioactive material, is released toward a containment building. The released core melt erodes the floor of the containment structure by decay heat continuously generated from the core melt.

This situation reflects the principally remaining risks in the nuclear plant, in that, unless arrested, it causes environmental radioactivity either by ultimate penetration of the cavity floor or by the buildup of non-condensable gas pressure (i.e., pressurizing the containment building structure).

The risks result from a consequence of the melt attack and decomposition of the concrete floor.

Accordingly, a principal goal of research and development in the related field is to design a robust boundary capable of withstanding melt attack, thus bringing the melt progression to permanent arrest. For this, a wide variety of concepts have been considered, in the form of materials (sacrificial materials), devices (an array of upward pointing tubes, that once the tube array is melted by the melt, releases water to cool it), or mechanisms (the natural cooling and eventual solidification of a fuel melt layer on the concrete floor, water filling on top of the melt).

However, none of these have shown utility at the required high confidence level and been applied practically.

### SUMMARY OF THE INVENTION

It is, therefore, an object of the present invention to provide an ex-vessel core melt retention device preventing molten core concrete interaction, which can arrest the passage of core melt in a high reliability regardless of the progression and the change of flow route of the core melt even when the a reactor vessel is melted and damaged that is one of severe accidents in a nuclear plant.

It is another object of the present invention to provide an ex-vessel core melt retention device preventing molten core concrete interaction, which has a boundary capable of completely arresting the passage of the core melt through a reactor vessel floor regardless of the progression and the change of flow route of the core melt, thereby cooling and retaining the core melt within a containment building.

To achieve the above objects, the present invention provides an ex-vessel core melt retention device preventing molten core concrete interaction, which is installed for alleviating risks due to unexpected accidents over accidents considered as a design criteria of a nuclear plant, the device comprising: horizontal jacket pipes located on a shell boundary of a cavity floor, the horizontal jacket pipes having water inlets A formed at their lower half in an appropriate density, the water inlets allowing water to enter the bottom of the pipes; vertical pipes connected at both ends of the horizontal jacket pipes in the form of a dovetail to communicate with each other; and a water supply part located at the lower portion of the horizontal jacket pipes for allowing water to enter from the whole area of the bottom.

The water supply part includes shallow water channels being engraved into the cavity floor, in which the horizontal pipes are installed, and running crosswise to the horizontal pipes. Alternatively, the water supply part includes horizontal supply pipes, which are arranged normal to and beneath the horizontal jacket pipes and have water inlets B formed in all directions and locations.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the drawings.

In the drawings:

FIG. 1 is a sectional view of a pipe connection part being in the form of dovetail according to the present invention;

FIG. 2 is a sectional view of a flow supply system according to a preferred embodiment of the present invention; and

FIG. 3 is a sectional view of a supply piping system according to another preferred embodiment of the present invention.

### DETAILED DESCRIPTION OF THE PREFERRED EMBODIMENT

The present invention will now be described in connection with preferred embodiments with reference to the accompanying drawings.

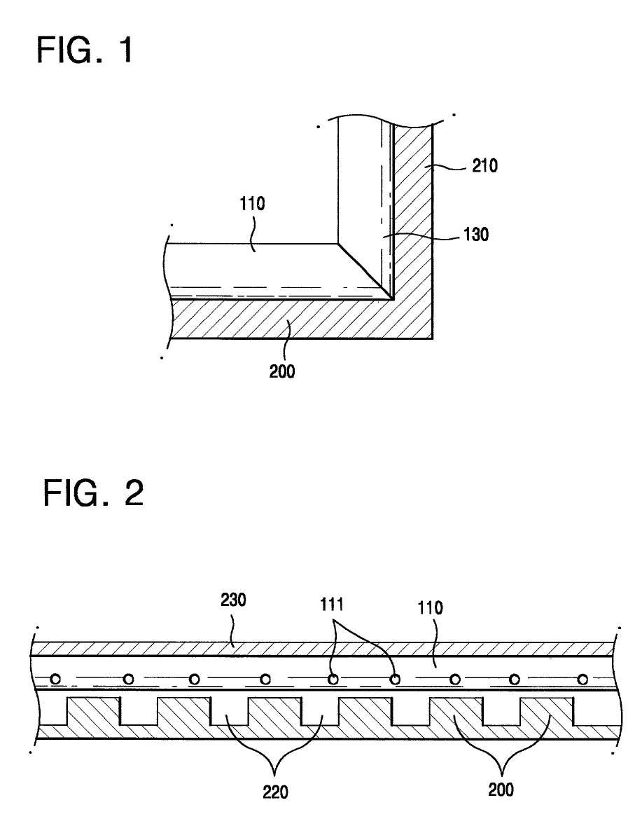

FIG. 1 is a partially sectional view showing a state that the present invention is embodied. Horizontal jacket pipes 110, which are installed on a shell boundary of a cavity floor 200, are slightly bent upwards and connected with vertical pipes 130 at both ends like a dovetail as shown in FIG. 1. There is no need for great precision here; all that is needed is that fluid from the horizontal jacket pipes 110 have to escape through the corresponding vertical pipes 130.

Therefore, as shown in FIG. 1, a simple cut in the walls of the reactor cavity should be quite sufficient for this purpose.

The horizontal jacket pipes 110 are oriented along the narrow dimension of the cavity floor 200 and have water inlets 111 formed at their lower half in an appropriate density. The design allows the water to enter the bottom of the pipes and vapor produced by water boiling to exit through the vertical pipes 130. At this time, gravity assures passive circulation of water under the water boiling conditions. All that is needed is a radius of curvature of the horizontal jacket pipes 110. Preferably, the radius of curvature is about 20 m. In this case, the elevation from the center of the horizontal jacket pipes 110 to the wall 210 of the reactor cavity is about 20 cm.

The present invention takes two methods that the water enters from the bottom of the horizontal jacket pipes 110 over the whole area.

FIG. 2 is a sectional view of a flow supply system according to a preferred embodiment of the present invention. Shallow water channels 220 are engraved into the cavity floor 200, in which the horizontal jacket pipes 110 are installed, and run crosswise to the horizontal jacket pipes 110.

The horizontal jacket pipes 110 have a number of water inlets A 111 formed at the lower portions thereof.

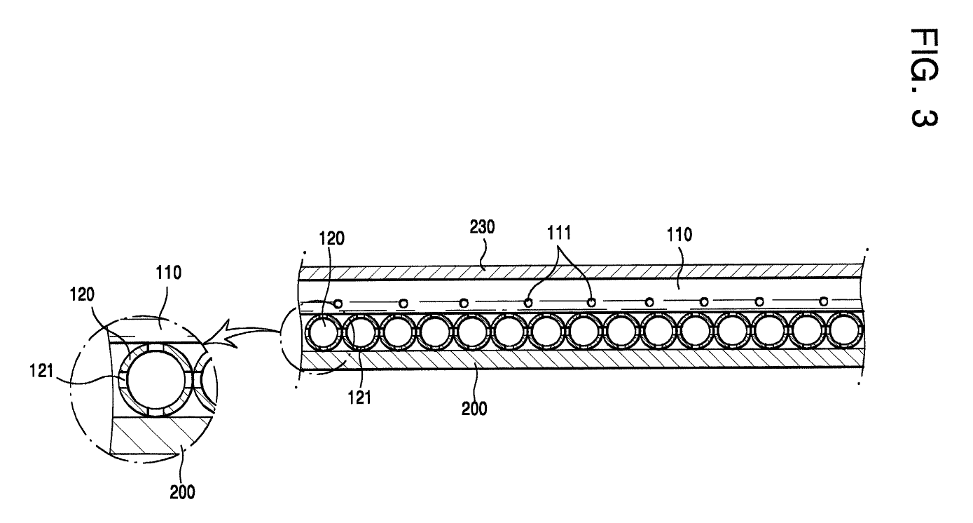

FIG. 3 is a sectional view of a supply piping system according to another preferred embodiment of the present invention. As shown in FIG. 3, horizontal supply pipes 120 are arranged normal to and beneath the horizontal jacket pipes 110. The horizontal supply pipes 120 have water inlets B 121 formed in all directions and locations.

The horizontal supply pipes 120 run along the length of the cavity floor 200.

In the methods presented according to the embodiments shown in FIGS. 2 and 3, the radius of curvature needed to support the horizontal jacket pipes 110 is obtained by appropriately shaping the cavity floor 200.

It is not necessary to perforate water inlets into the vertical pipes 130 of the cavity wall 210.

Diameter and thickness of the horizontal jacket pipes 110 and the vertical pipes 130 may be selected flexibly. Preferably, typical values of the pipes are about 1˜2 inches in diameter and 0.5 inch in thickness. On the upper surface, the horizontal jacket pipes are covered with a concrete layer 230 to protect against direct ablation caused by the melt and against damage caused by loads from the interaction between nuclear fuel and water.

The loads may be minimized by keeping the water 0.5 m or less in depth and eliminated by injecting the water into the cavity floor 200 after the melt is released from the reactor vessel.

The cooling power to the nuclear melt released after the core melt accident may be achieved by the following Design Criteria:

D.C. 1: Capture and contain all melt debris released from the reactor vessel;

D.C. 2: Withstand all thermal loads generated from the debris, both during relocation and in a steady state of the melt; and

D.C. 3: Withstand all structural loads generated from potential energetic fuel-water interactions.

These Design Criteria translate in turn to the following Design Guidelines, respectively:

D.G. 1: The present invention must be applied to all cavity flow areas in consideration of the mechanism to eject the melt to effectively capture the released melt;

D.G. 2: With full immersion in the water, “Focusing problem” of heat generated by fission product of the melt must be automatically eliminated, and the only and general guidelines on thermal performance are to maximize the surface-to-volume ratio, to allow continuous rising of the water from the bottom and to have surface inclinations that ensure adequate vapor rise to remove at all heated parts of the boundary.

D.G. 3: In simplicity and ease of structural design, the water pool depth must be minimized to minimize the loads caused by the generated vapor release.

Therefore, the present invention includes the horizontal jacket pipes 110, which completely cover the cavity floor 200 to serve as a protective shield to the cavity floor 200, and the vertical pipes 130 of 1 m to 3 m. This structure is made up of steel pipes arranged closely, and there are the water inlets 111 for allowing water to enter and to circulate freely among them.

Therefore, heat generated by the fission product of the melt is removed by boiling the water supplied into the top of the horizontal jacket pipes 110. Furthermore, when the thermal load from the melt is lower than the heat removal capacity by boiling, the melt is solidified and thereby the horizontal jacket pipes 110 and the vertical pipes 130 are protected from the high temperature melt.

The cooling power can be readily shown even in very high power reactors with electrical output of about 1,600MW.

As described above, the present invention, which has the boundary preventing the passage of the melt, can retain and cool the core melt within the containment building and prevent radioactive material from exiting outside the containment building, regardless of the progression and the change of flow route of the core melt even when the molten core overheats or damages the reactor vessel.

In comparison with the prior arts, the present invention is a passive device that is simple in manufacture and installation and has an advantage that it can be easily installed regardless of kinds or output capability of nuclear plants.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An ex-vessel core melt retention device preventing molten core concrete interaction, which is installed for alleviating risks due to unexpected accidents over accidents considered as a design criteria of a nuclear plant, the device comprising:
horizontal jacket pipes located on a shell boundary of a cavity floor, the horizontal jacket pipes having water inlets A formed at their lower half in an appropriate density, the water inlets allowing water to enter the bottom of the pipes;
vertical pipes connected at both ends of the horizontal jacket pipes in the form of a dovetail to communicate with each other; and
a water supply part located at the lower portion of the horizontal jacket pipes for allowing water to enter from the whole area of the bottom.

2. The device as claimed in claim 1, wherein the water supply part includes shallow water channels being engraved into the cavity floor, in which the horizontal pipes are installed, and running crosswise to the horizontal pipes.

3. The device as claimed in claim 1, wherein the water supply part includes horizontal supply pipes which is arranged normal to and beneath the horizontal jacket pipes and has water inlets B formed in all directions and locations.
